(19) United States
(12) Patent Application Publication
(10) Pub. No.: US 2006/0200343 A1
(43) Pub. Date: Sep. 7, 2006

(54) Enhanced data storage

(76) Inventor: Glenn Mark Wakefield, Tempe, AZ (US)

Correspondence Address: Glenn Wakefield, 1416 East Carmen Street, Tempe, AZ, 85283, US

(21) Appl. No.: 11/361,859

(22) Filed: Feb. 24, 2006

Related U.S. Application Data
(60) Provisional application No. 60/657,459, filed on Mar. 1, 2005.

(51) Int. Cl. G06F 17/21

(52) U.S. Cl. 704/10

(57) ABSTRACT

An electronic device that includes a stored data stream composed of dictionary entries. Each dictionary entry or coded data correlates with video or audio (spoken, music or other). Spoken words will have one or more dictionary entries to allow for different quality enunciations, pronunciations, inflections, accents and tones. These qualities will allow the characterization and replication of any human voice. The electronic device will have the capacity to increase information storage density.

### CROSS-REFERENCE TO RELATED APPLICATIONS

Provisional application No. 60/657,459, filed March 2005.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This patent application applies to the field of audio and video technology.

Advanced audio and video technology has centered on the digitization and processing of data. Relatively minimal work has been done in regards to efficient audio storage and manipulation of the human voice.

### BRIEF SUMMARY OF THE INVENTION

An electronic device that includes a stored data stream composed of dictionary entries. Each dictionary entry or coded data correlates with video or audio (spoken, music or other). Spoken words will have one or more dictionary entries to allow for different quality enunciations, pronunciations, inflections, accents and tones. These qualities will allow the characterization and replication of any human voice. The electronic device will have the capacity to increase information storage density.

### BRIEF DESCRIPTION OF THE SEVERAL VIEWS OF THE DRAWING

Not Applicable

### DETAILED DESCRIPTION OF THE INVENTION

Storing information in a digital format involves significant storage space. The following method allows for an increase in the total play time. It may be applied to any electronic device (i.e. CD/DVD, computer, cell phone, video camera, digital camera and etcetera). An appropriate mechanism will exist for the simultaneous interface with one or more pieces of electronic equipment that will allow for control instructions and data to flow in any direction among all the electronic equipment. The electronic device will have interfaces that include one or more screens, speakers, microphones, inputs (i.e. keypads), transmitters, receivers and fixed and transferable storage medium. The electronic device will include all appropriate hardware, software and ergonomic features. A dictionary will be established that correlates coded data with a sound (spoken, music or other) or with a video image. The following description conveys one basic method in which the electronic device may function. When the storage medium is placed in the electronic device, the electronic device will transfer the entire dictionary to its memory chips. As the electronic device simultaneously reads one or more streams of coded data, it will look up the corresponding sound or video information. This information will be transferred to one or more appropriate interfaces as described above.

The coded audio will be able to replicate any human voice in any language. The screen may display the words in conjunction with the sound and video. For example, thunder with appropriate sound and video. The electronic device may have a very large dictionary. Words recognized or not recognized may be pronounced as appropriate by the dictionary entry, syllables, phonemes, spelled symbol by symbol or any other method. Words will be listed several times in the dictionary to allow for different quality enunciations, pronunciations, inflections, accents and tones. Information regarding timing of or between words and timing relative to punctuation may be encoded in the digital stream. Part of a dictionary entry may be set aside for characteristics of a word that does not entail a unique entry. For example, several bits may establish the timing interval for the pronunciation of a word without having a unique dictionary entry for each different pronunciation time. Surround sound may be recorded in the digital stream. A music disc may contain details about the singer, songs, instrumentation and other information. The electronic device will have the ability to operate as a universal translator. This will involve the pickup, processing, translation and output of a series of sounds in one language into another language. The electronic device will be able to digitally process both audio and video data. The electronic device will have the ability to increase or decrease the timing interval of each piece of data or between data (i.e. video, audio). All of the features of the electronic device may be programmed using an appropriate computer language to allow for a very flexible system. This would allow any coded data (i.e. video, audio) to undergo major modification. For a small amount of storage space this will allow all data to be heard, visualized and read. As storage density continues to increase with time, the storage space required by the dictionary will continue to decline. The appropriate introduction, combination and modification of standardized data formats will be implemented to incorporate all of these concepts discussed above.

I claim:

1. An electronic device that is characterized by the following:
interfaces that include one or more screens, speakers, microphones, inputs (i.e.keypads), transmitters, receivers and fixed and transferable storage medium;
all appropriate hardware, software and ergonomic features;
a dictionary that correlates coded data with a sound (i.e. spoken, music or other) or with a video image;
the simultaneous reading of one or more streams of coded data with the appropriate translation and transfer of data to the correct interface;
an appropriate mechanism for the simultaneous interface with one or more pieces of electronic equipment that will allow for control instructions and data to flow in any direction among all the electronic equipment.

2. Referring to the electronic device in claim 1, the coded audio will be able to replicate any human voice in any language..

3. Referring to the electronic device in claim 1, the screen may display the words in conjunction with sound and video (i.e. thunder with appropriate sound and video).

4. Referring to the electronic device in claim 1, words recognized or not recognized may be pronounced as appropriate by the dictionary entry, syllables, phonemes, spelled symbol by symbol or any other method.

5. Referring to the electronic device in claim 1, words will be listed several times in the dictionary to allow for different quality enunciations, pronunciations, inflections, accents and tones.

6. Referring to the electronic device in claim 1, information regarding timing of or between words and timing relative to punctuation may be encoded in the digital stream.

7. Referring to the electronic device in claim 1, part of a dictionary entry may be set aside for characteristics of a word that does not entail a unique entry (i.e. several bits may establish the timing interval for the pronunciation of a word without having a unique dictionary entry for each different pronunciation time).

8. Referring to the electronic device in claim 1, surround sound may be recorded in the digital stream.

9. Referring to the electronic device in claim 1, a music disc may contain details about the singer, songs, instrumentation and other information.

10. Referring to the electronic device in claim 1, the electronic device will have the ability to operate as a universal translator which wilt involve the pickup, processing, translation and output of a series of sounds in one language into another language.

11. Referring to the electronic device in claim 1, the electronic device will be able to digitally process both audio and video data.

12. Referring to the electronic device in claim 1, the electronic device will have the ability to change the timing interval of each piece of data or between data (i.e. video, audio).

13. Referring to the electronic device in claim 1, all of the features of the electronic device may be programmed using an appropriate computer language to allow for a very flexible system.

14. Referring to the electronic device in claim 1, the appropriate introduction, combination and modification of standardized data formats will be implemented to incorporate all of these concepts discussed above.
